(19) United States
(12) Patent Application Publication
(10) Pub. No.: US 2006/0082685 A1
(43) Pub. Date: Apr. 20, 2006

(54) PIP image reproducing apparatus for image reproducing during firmware upgrade of cable card and image reproducing method using the same

(75) Inventors: Kyung-chul Nam, Suwon-si (KR); Eun-kyung Kang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/229,608

(22) Filed: Sep. 20, 2005

(30) Foreign Application Priority Data
Oct. 18, 2004 (KR) 10-2004-82975

(51) Int. Cl. H04N 7/16

(52) U.S. Cl. 348/565; 725/152

(57) ABSTRACT

A picture in picture (PIP) image reproducing apparatus and method are provided which is capable of image reproducing during a firmware upgrade of a cable card in which, an image signal that is displayed a main screen is switched to an auxiliary screen if tuning for a homing signal for upgrading the cable card interferes with the reproduction of the image signal that is currently being displayed on the main screen. As a result of switching the image displayed on the main screen to the auxiliary screen, the image can be continuously viewed even while the upgrade of the cable card occurs. In addition, if no image signal is being displayed on the auxiliary screen at the time when the homing signal is received, an input signal may be selected and displayed in the main screen while the image signal which was previously displayed in the main screen is reproduced on the auxiliary screen.

### CROSS-REFERENCE TO RELATED APPLICATIONS

This application claims priority from Korean Patent Application No. 10-2004-82975, filed on Oct. 18, 2004, the entire content of which is incorporated herein by reference.

### BACKGROUND OF THE INVENTION

1. Field of the Invention

Apparatuses and methods consistent with the present invention relate to a picture-in-picture (PIP) image reproducing apparatus for image reproduction during a firmware upgrade of a cable card and an image reproducing method using the same, in which a image which is displayed can be continuously viewed even when a firmware upgrade of the cable card occurs.

2. Description of the Related Art

A PIP function in an image reproducing apparatus refers to an additional small PIP screen display that can be simultaneously displayed in addition to a main screen display. With respect to the screens that are displayed by an image reproducing apparatus with a PIP function, the background region is called the main screen display and the smaller sized region is called the PIP screen display, which are referred to as a main screen and an auxiliary screen, respectively.

The PIP image reproducing apparatus generally includes a main tuner for reproducing a main image and an auxiliary tuner for reproducing an auxiliary image. In the case of an image reproducing apparatus for reproducing an analog broadcast signal, a separate tuner is generally provided for each of the auxiliary images that are displayed. Further, if the number of auxiliary images is greater than the number of tuners, the auxiliary images may be displayed as still images and positioned on a part of the main screen.

In the case of an image reproducing apparatus for receiving and reproducing a digital broadcast, the PIP function can be conducted without using a separate auxiliary tuner. Thus, the digital image reproducing apparatus can process multiple images from different signals (e.g., channels) even with a single tuner by virtue of digitally decoding the digital broadcast signal.

In such a PIP image reproducing apparatus, a firmware upgrade of a cable card may be performed to receive upgrade data from a cable television system operator (CATV SO). The CATV SO transmits the firmware upgrade signal of a cable card to the image reproducing apparatus, which is received and processed in order to perform an upgrade of the cable card.

However, during a firmware upgrade of the cable card, tuning for the upgrade signal may effect the frequency bandwidth of the image signal being viewed by a user, such that the user may be hindered in watching broadcasting image when the firmware upgrade occurs. Therefore, it is desirable to provide the capability of continuously viewing an image being displayed on the main screen of the PIP image reproducing apparatus during the firmware upgrade of the cable card.

### SUMMARY OF THE INVENTION

Accordingly, it is an object of the present invention to provide a PIP image reproducing apparatus capable of image reproduction during a firmware upgrade of a cable card and an image reproducing method using the same, in which upon the firmware upgrade of the cable card, an image signal that is displayed on a main screen is switched to an auxiliary screen so that user can continuously watch the image signal on the auxiliary screen.

The above and other aspects of the present invention are substantially realized by providing a method for reproducing an image signal during a firmware upgrade of a cable card, the method comprising: (a) if a homing signal for the firmware upgrade of the cable card is received by a picture in picture (PIP) image reproducing apparatus, determining whether receiving the homing signal interferes with reproduction of a first image signal, which is displayed on a main screen; (b) if receiving the homing signal is determined to interfere with reproduction of the first image signal, which is displayed on the main screen, determining whether a second image signal is displayed on an auxiliary screen; (c) if the second image signal is determined to be displayed on the auxiliary screen, switching the first image signal to the auxiliary screen and the second image signal to the main screen; and (d) upgrading a firmware of the cable card based on the homing signal.

Also, in (a), if receiving the homing signal is not determined to interfere with the reproduction of the first image signal, which is displayed on the main screen, the firmware of the cable card may be upgraded based on the homing signal.

In addition, in (c), if the second image signal is not displayed on the auxiliary screen, selecting an input signal for the second image signal and switching the first image signal to the auxiliary screen and the second image signal to the main screen.

Also, in (c), if the second input signal is not displayed on the auxiliary screen, determining whether to switch the first image signal to the auxiliary screen and then selecting an input signal for the second image signal if the first image signal is switched to the auxiliary screen.

Additionally, if it is determined to switch the first image signal, which is displayed on the main screen, to the auxiliary screen, the input signal for the second image signal is selected, and if it is not determined to switch the first image signal from the main screen to the auxiliary screen, the firmware of the cable card is upgraded based on the homing signal.

Also, the homing signal may include at least any one of a message, data and a time for the firmware upgrade of the cable card.

In accordance with another aspect of the present invention, there is provided a PIP image reproducing apparatus for reproducing an image during a firmware upgrade of a cable card, comprising: a control unit which determines whether receiving a homing signal for the firmware upgrade of the cable card interferes with reproduction of a first image signal, which is displayed on a main screen, and whether a second image signal is displayed on an auxiliary screen; an input source selecting unit which selects an input signal for the second image signal if receiving the homing signal is determined to interfere with reproduction of the first image signal and the second image signal is not displayed on the auxiliary screen; a screen switching unit which switches the first image signal to the auxiliary screen and the second image signal to the main screen if receiving the homing signal is determined to interfere with reproduction of the first image signal and the second image signal is determined to be displayed on the auxiliary screen; and a homing processing unit which upgrades a firmware of the cable card based on the homing signal.

Additionally, the homing signal may include at least any one of a time, data and a message for the firmware upgrade of the cable card.

Also, if the second image signal is not displayed on the auxiliary screen, the control unit determines whether to switch the first image signal, which is displayed on the main screen, to the auxiliary screen.

In addition, if receiving the homing signal is determined to interfere with reproduction of the first image signal, which is displayed on the main screen, and if the second video signal is not displayed on the auxiliary screen, an input signal for the second video signal is selected and the screen switching unit switches the first image signal to the auxiliary screen and the second image signal to the main screen.

### BRIEF DESCRIPTION OF THE DRAWINGS

The above and other aspects of the present invention will be more apparent by describing certain exemplary embodiments of the present invention with reference to the accompanying drawings, in which:

FIG. 1 is a block diagram of a PIP image reproducing apparatus capable of image reproducing during a firmware upgrade of a cable card in accordance with an exemplary embodiment of the present invention; and

FIG. 2 is a flow chart for illustrating a method for image reproducing during a firmware upgrade of a cable card in accordance with an exemplary embodiment of the present invention.

### DETAILED DESCRIPTION OF THE EXEMPLARY EMBODIMENTS

Hereinafter, exemplary embodiments of the present invention will be described in detail with reference to the attached drawings.

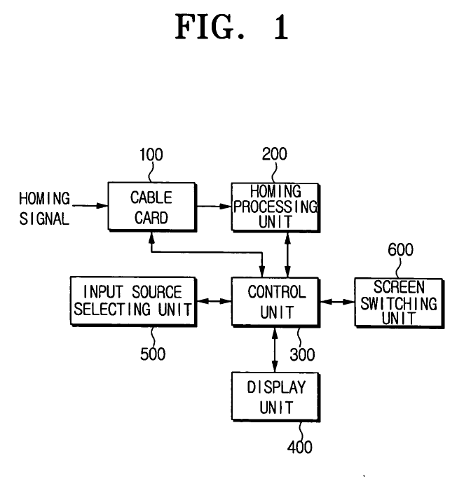

FIG. 1 is a block diagram of a PIP image reproducing apparatus capable of image reproducing upon a firmware upgrade of a cable card in accordance with an exemplary embodiment of the present invention.

Referring to FIG. 1, the PIP image reproducing apparatus capable of image reproducing upon the firmware upgrade of the cable card according to an exemplary embodiment of the present invention comprises a cable card 100, a homing processing unit 200, a control unit 300, a display unit 400, an input source selecting unit 500 and a screen switching unit 600.

First, the cable card 100 receives video signals which are transmitted from a cable television system operator (CATV SO). This cable card 100 is different in accordance with the particular CATV SO, and when the homing signal is transmitted from the CATV SO, firmware of the cable card is upgraded. The homing signal which is received by the cable card 100 is transmitted to the homing processing unit 200. Further, the homing signal may include information such as a message, a homing time, data, etc., which are used for the firmware upgrade of the cable card 100 from the CATV SO.

When the homing signal is received by the cable card 100, the homing processing unit 200 tunes the homing signal in order to upgrade the firmware of the cable card 100 by processing transmitted data which is included in the homing signal.

The display unit 400 displays an image signal from among broadcast signals that are received and processed from a broadcasting station or the CATV. Display unit 400 can display a message informing the user that a homing signal is received and the user can then select whether to switch the first image signal, which is displayed in the main screen, to the auxiliary screen. In the case of PIP image reproducing apparatus, two or more pictures can be displayed on the display unit 400. In addition, the user can select which image signal is to be reproduced on the main and auxiliary screens and is further able to switch the image signals that are displayed in the main and auxiliary screens by the use of input keys and so on of an operating panel (not shown).

The input source selecting unit 500 selects an image signal to be reproduced on the main screen after switching the main and auxiliary screens if no image signal is being currently displayed in the auxiliary screen when the homing signal is received. This is because the auxiliary screen is only displayed when an image is also being displayed in a main screen

The screen switching unit 600 switches an image signal which is currently being displayed on the main screen (i.e., a first image signal) to the auxiliary screen and switches the image signal that is displayed on the auxiliary screen (i.e., a second image signal) to the main screen. Thus, if the homing signal, which upgrades the cable card, interferes with the reproduction of an image signal on the main screen, the image signal being displayed on the main screen is moved into the auxiliary screen. If there is an image signal being reproduced on the auxiliary screen before the screen switching of the main and auxiliary screens, the image signal being reproduced on the auxiliary screen is displayed on the main screen according to screen switching of the main and auxiliary screens by the screen switching unit 600. However, if an image signal being reproduced on the auxiliary screen does not exist, the screen switching is conducted after an input source to be displayed on the main screen after the screen switching is selected.

Meanwhile, the screen switching of the main and auxiliary screens can be conducted not only by the screen switching unit 600 but also by the user's selection. A message may be displayed on the display unit 400 which inquires as to whether screen switching is desired, so that the user can select screen switching. This is because as circumstances require, during the firmware upgrade of the cable card 100, a user may not want to view an image signal, which is currently displayed on the main screen, as an image switched to the auxiliary screen.

The control unit 300 generally controls an operation of the respective components. If viewing of an image signal on the main screen is interfered by receiving the homing signal, the control unit controls an operation of the screen switching unit 600 so as to move the image signal being viewed on the main screen into the auxiliary screen. The control unit 300 controls an operation of the display unit 400 for displaying a homing message informing the user of the firmware upgrade of the cable card 100 and a message inquiring as to whether switching of the main and auxiliary screens is desired.

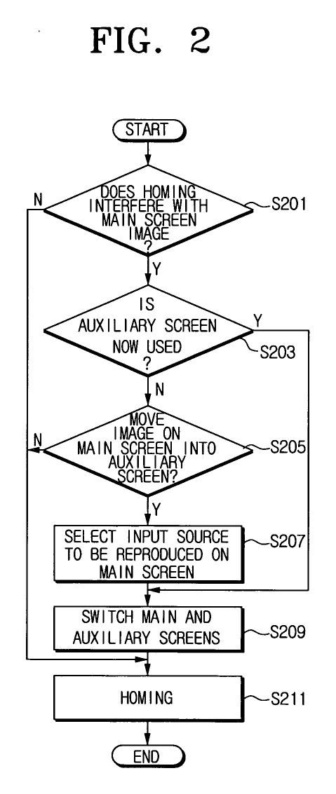

FIG. 2 is a flow chart which illustrates a method for image display during a firmware upgrade of a cable card in accordance with an exemplary embodiment of the present invention.

Referring to FIG. 2, first, when the homing signal is received to the cable card, it is determined whether receiving the homing signal interferes with reproduction of a first image signal, which is displayed on the main screen (S201). The reproduction of the first image signal may be intermittently interrupted on the main screen by the tuning of the homing signal. Thus, in the case that receiving the homing signal is determined to interfere with reproduction of the first image signal, the main and auxiliary screens are switched so as to allow the user to view the first image signal on the auxiliary screen.

If it is determined that receiving the homing signal interferes with the reproduction of the first image signal, it is determined whether there is also an second image signal being reproduced on the auxiliary screen (S203).

If there is no second image signal being reproduced on the auxiliary screen, it is determined whether to move the first image signal being reproduced on the main screen into the auxiliary screen (S205). The determination may be done by displaying on the display unit 400 a message inquiring as to whether the first image signal, which is being reproduced on the main screen, should be moved into the auxiliary screen, and allowing the user to select whether to move the first image signal to the auxiliary screen by use of the input keys and so on of the operating panel (not shown). This is because as circumstances require, during the firmware upgrade of the cable card 100, a user may not want to view an image, which is currently being displayed on the main screen, on the auxiliary screen through screen switching. However, if there is no image being reproduced on the auxiliary screen, the main and auxiliary screens can be switched without determining whether to move an image being reproduced on the main screen into the auxiliary screen. Thus, the user can continuously view the image signal through the movement to the auxiliary screen by means of the screen switching when the homing signal is being received.

When the reproducing image on the main screen is to be moved into the auxiliary screen, an input source to be reproduced on the main screen is selected (S207). The selection of the input source to be reproduced on the main screen renders, upon the screen switching, an image being reproduced on the main screen moved into the auxiliary screen, and renders an image of the selected input source displayed on the main screen. The input source to be reproduced on the main screen can be selected not only by the input source selecting unit 500 but also by the user using the input keys and so on.

Then, the main and auxiliary screens are switched with each other at the screen switching unit 600 (S209). The switching of the main and auxiliary screens makes it possible for the currently displayed image on the main screen to be moved into the auxiliary screen and for the input source selected at the input source selecting unit 500 to be displayed on the main screen. As a result, even while the the homing signal is being received, the user can view the image signal, which was displayed on the main screen, moved to the auxiliary screen when the homing signal is received.

Further, if it is determined that there is also an image being reproduced on the auxiliary screen in the step S203, the main and auxiliary screens can be switched into each other without necessitating the selection of the input source to be reproduced on the main screen, so that although the homing signal is received, the viewing image on the main screen can be looked and listened at the auxiliary screen.

The switching of the main and auxiliary screens is done at the screen switching unit 600 after the determination by the control unit 300 as to the existence or absence of the image signal on the auxiliary screen, or after the selection by the input source selecting unit 600 for the input source to be reproduced on the main screen. However, in a case that there is an image signal displayed on the auxiliary screen, display unit 400 may display a message inquiring as to whether screen switching of the main and auxiliary screens is desired and allowing the user to select whether to perform the screen switching.

Then, after the switching of the reproducing image on the main screen into the auxiliary screen, the firmware of the cable card 100 can be upgraded (S21 1). Accordingly, the firmware of the cable card 100 is upgraded after the switching of the viewing image on the main screen into the auxiliary screen, so that the image signal displayed on the main screen is not impaired by the tuning of the homing signal for the firmware upgrade of the cable card 100.

Meanwhile, if it is not determined that receiving the homing signal interferes with the image signal being reproduced in the main screen in operation S201, or moving the image signal reproduced on the main screen to the auxiliary screen in operation S205 is not selected, the screen switching is not performed. This is because if it is not determined that receiving the homing signal interferes with reproduction of the image signal displayed in the main screen, the tuning for the homing signal is necessarily being performed at the auxiliary screen so that the reproduction of the image signal on the main screen is not impaired.

As described above, according to the present invention, in the case that the homing for the firmware upgrade of the cable card is done at the main screen, the reproducing image on the main screen is moved into the auxiliary screen, so that the user can view the image signal even when homing is performed.

The foregoing embodiments and advantages are merely exemplary and are not to be construed as limiting the present invention. The present teaching can be readily applied to other types of apparatuses. Further, the description of the exemplary embodiments of the present invention is intended to be illustrative, and not to limit the scope of the claims, and many alternatives, modifications, and variations will be apparent to those skilled in the art.

What is claimed is:

1. A method for reproducing an image signal during a firmware upgrade of a cable card of a picture-in-picture (PIP) image reproducing apparatus, the method comprising the steps of:
determining whether a homing signal for the firmware upgrade of the cable card interferes with reproduction of a first image signal which is displayed on a main screen;
determining whether a second image signal is displayed on an auxiliary screen if receiving the homing signal is determined to interfere with reproduction of the first image signal which is displayed on the main screen;
switching the display of the first image signal to the auxiliary screen and the display of the second image signal to the main screen if the second image signal is determined to be displayed on the auxiliary screen; and
upgrading a firmware of the cable card based on the homing signal.

2. The method of claim 1, wherein the firmware of the cable card is upgraded if receiving the homing signal is not determined to interfere with reproduction of the first image signal which is displayed on the main screen.

3. The method of claim 1, wherein the switching the display of the first image signal to the auxiliary screen and the display of the second image signal to the main screen if the second image signal is determined to be displayed on the auxiliary screen comprises selecting an input signal for the second image signal and switching the first image signal to the auxiliary screen and the second image signal to the main screen.

4. The method of claim 3, further comprising determining whether to switch the display of the first image signal to the auxiliary screen if it is determined that the second image signal is not displayed on the auxiliary screen.

5. The method of claim 4, further comprising upgrading the firmware of the cable card based on the homing signal if it is not determined to switch the display of the first image signal from the main screen to the auxiliary screen.

6. The method of claim 1, wherein the homing signal includes any one of a message, data and a time for the firmware upgrade of the cable card.

7. A picture-in-picture (PIP) image reproducing apparatus for reproducing a image signal during a firmware upgrade of a cable card, the PIP image reproducing apparatus comprising:
a control unit which determines whether receiving a homing signal for the firmware upgrade of the cable card interferes with reproduction of a first image signal, which is displayed on a main screen, and whether a second image signal is displayed on an auxiliary screen;
an input source selecting which selects an input signal for the second image signal if receiving the homing signal is determined to interfere with reproduction of the first image signal and the second image signal is not displayed on the auxiliary screen;
a screen switching unit which switches the display of the first image signal to the auxiliary screen and the display of the second image signal to the main screen if receiving the homing signal is determined to interfere with reception of the first image signal and the second image signal is determined to be displayed on the auxiliary screen; and
a homing processing unit which upgrades a firmware of the cable card based on the homing signal.

8. The PIP image reproducing apparatus of claim 7, wherein the homing signal includes at least any one of a time, data and a message for the firmware upgrade of the cable card.

9. The PIP image reproducing apparatus of claim 7, wherein if the second image signal is not displayed on the auxiliary screen, the control unit determines whether to switch the display of the first image signal which is displayed on the main screen to the auxiliary screen.

10. The PIP image reproducing apparatus of claim 7, wherein if receiving the homing signal is determined to interfere with reproduction of the first image signal which is displayed on the main screen and if the second image signal is not displayed on the auxiliary screen, a signal for the second image signal is selected and the screen switching unit switches the display of the first image signal to the auxiliary screen and the display of the second image signal to the main screen.
